(19) United States
(12) Patent Application Publication
(10) Pub. No.: US 2005/0076823 A1
(43) Pub. Date: Apr. 14, 2005

(54) Memorabilia display device

(76) Inventor: Todd A. Sanders, Ponte Vedra Beach, FL (US)

Correspondence Address: Mark J. Young, Suite 227, 9951 Atlantic Blvd., Jacksonville, FL, 32225, US

(21) Appl. No.: 10/902,630

(22) Filed: Jul. 28, 2004

Related U.S. Application Data
(60) Provisional application No. 60/490,465, filed on Jul. 28, 2003.

(51) Int. Cl. G09F 17/00

(52) U.S. Cl. 116/173

(57) ABSTRACT

A display device includes a lifting body, such as a kite or a buoyant object. A vehicle attachment device is provided for securing the device to a stationary object, such as to the bumper, door or window of a parked motor vehicle. A tether secures the lifting body to the vehicle attachment devices. Swivels and releasable tether attachment devices may be provided for attaching the tether to the vehicle attachment devices and for attaching the tether to the lifting body. A plurality of ornaments, such as memorabilia, banners, pennants, logos, decorations, flags, advertisements and/or other indicia are provided for releasable attachment to the tether. Ornament attachment devices are also provided for releasably securing ornaments to the tether at desired positions.

### RELATED APPLICATIONS

This application claims priority to U.S. Provisional Application 60/490,465, filed Jul. 28, 2003, the entire contents of which are incorporated by reference therein.

### FIELD OF THE INVENTION

The present invention relates generally to display of ornaments, such as memorabilia, pennants, logos, flags, advertisements or other indicia. More particularly, the present invention relates to a device and method for displaying ornaments by releasable attachment to a tether attached to a stationary object and a lifting body.

### BACKGROUND

A typical method of advertising and/or showing support for an athlete, celebrity, team, organization, political group or country is by displaying memorabilia, pennants, logos, flags or indicia on a vehicle. Various display means and methods of securing them to a vehicle are known in the art. For example, window and door-mounted masts having brackets secured between parts of the vehicle are known in the art. Roof and trunk mounted displays, stickers, magnetically mounted items and devices for attachment to antennas are also known in the art. As these devices are generally designed for attachment and display on a moving vehicle, they are limited, such as in height and movement. These limitations reduce the overall effectiveness of the device as a conspicuous display.

Another disadvantage of such conventional displays is that they do not provide flexibility in the positioning and number of items displayed. For example, a device mounted to an automobile door typically does not accommodate a plurality of flags or pennants as may be desired by the user. Such conventional devices typically accommodate one flag or pennant, which is fixed to the device.

An inexpensive, aesthetically pleasing, conspicuous display means for attachment to a stationary object, such as a parked motor vehicle, is needed. The display means should be visible from significant distances, movable to attract attention and accommodate a plurality of displays.

A preferred embodiment of the present invention fulfills these needs and provides other related advantages.

### SUMMARY

The present invention provides a display device including a lifting body, such as a kite or a buoyant object. A vehicle attachment devices is provided for securing the device to a stationary object, such as to the bumper, door or window of a parked motor vehicle. A tether secures the lifting body to the vehicle attachment devices. Swivels and releasable tether attachment devices may be provided for attaching the tether to the vehicle attachment devices and for attaching the tether to the lifting body. A plurality of displays, such as memorabilia, banners, pennants, logos, decorations, flags, advertisements and/or other indicia (hereinafter referred to collectively as “ornaments”) are provided for releasable attachment to the tether. Ornament attachment devices are also provided for releasably securing ornaments to the tether at desired positions.

It is therefore an object of the present invention to provide a display means for attachment to a stationary object, such as a parked motor vehicle.

It is another object of the invention to provide a display means for attachment to a stationary object, such as a parked motor vehicle, wherein the display means is aesthetically pleasing and conspicuous.

It is also another object of the invention to provide a display means for attachment to a stationary object, such as a parked motor vehicle, wherein the display means is visible from substantial distances.

### BRIEF DESCRIPTION OF THE DRAWINGS

The foregoing and other objects, features and advantages of the present invention will become better understood with reference to the following description, appended claims, and accompanying drawings, where:

FIG. 1 conceptually illustrates an exemplary display device in accordance with a preferred embodiment of the present invention.

FIGS. 2A through 2E conceptually illustrate exemplary vehicle attachment devices in accordance with a preferred embodiment of the present invention.

FIG. 3 conceptually illustrates an exemplary swivel and releasable tether attachment devices in accordance with a preferred embodiment of the present invention.

FIG. 4 conceptually illustrates an exemplary ornament in accordance with a preferred embodiment of the present invention.

FIG. 5 conceptually illustrates exemplary ornament attachment devices in accordance with a preferred embodiment of the present invention.

### DETAILED DESCRIPTION

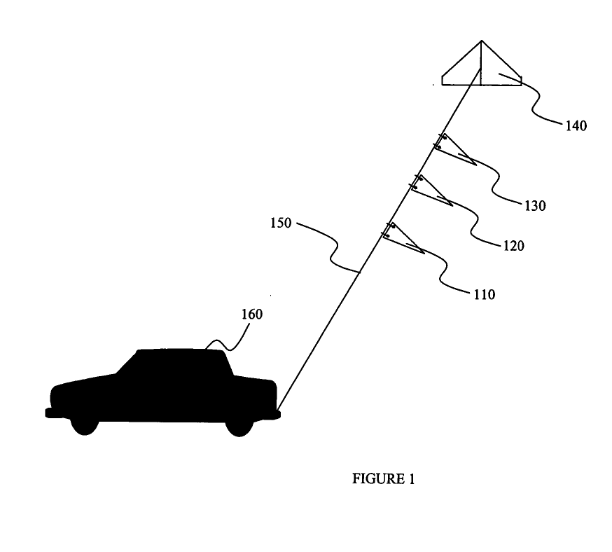

Referring now to FIG. 1, an exemplary display device in accordance with a preferred embodiment of the present invention is shown. A lifting body 140 in flight is attached to tether 120, which is attached to stationary object 190. While the lifting body shown is a kite, other means for providing lift such as buoyant objects (e.g., balloons filled with a gas that is lighter than ambient air) may be used without departing from the scope of the present invention. As such lifting bodies are well known, their construction is not addressed herein.

The lifting body 140 should be sized large enough to provide sufficient lifting force to support the tether 150 and hardware, including any swivels and releasable tether attachment devices attached to the tether, a plurality of ornaments 110-130 for releasable attachment to the tether, and ornament attachment devices for releasably securing ornaments to the tether. However, the lifting body is preferably small enough for easy storage in a motor vehicle. As an example, a conventional delta-shaped kite comprised of nylon material with a fiberglass frame and having a fifty-four (54) inch wing span, from wing tip to wing tip, and a length (from nose to trailing edge) of twenty-eight (28) inches is suitable for providing adequate lifting force for a preferred embodiment of the present invention in winds of approximately at least six miles per hour. Those skilled in the art will appreciate that other kite shapes (e.g., animals, ships, planes, diamonds, parafoils, cells and dragons), dimensions and constructions (e.g., polyester material with a lightweight carbon composite frame) may be used without departing from the scope of the present invention. For instance, a lightweight kite design may be used to provide desired lifting force in light breezes (e.g., below six miles per hour). Additionally, a lifting body 140 requiring a plurality of tethers may also be used without departing from the scope of the present invention.

A buoyant lifting body such as a helium filled balloon offers the advantage of providing lift irrespective of the wind. A kit in accordance with the present invention may include a balloon for filling with helium, a compressed helium canister for filling the balloon, and a kite. The kite may be used on windy days, and would offer greater stability in windy conditions. The balloon may be used on days with insufficient wind.

Those skilled in the art will appreciate that any lifting object capable of vertically supporting a tether and accompanying ornaments and hardware may be used without departing from the scope of the invention. Preferably, the object is lightweight, portable, inexpensive, durable and capable of producing sufficient lift to support the tether, ornaments and hardware over a sustained period of time.

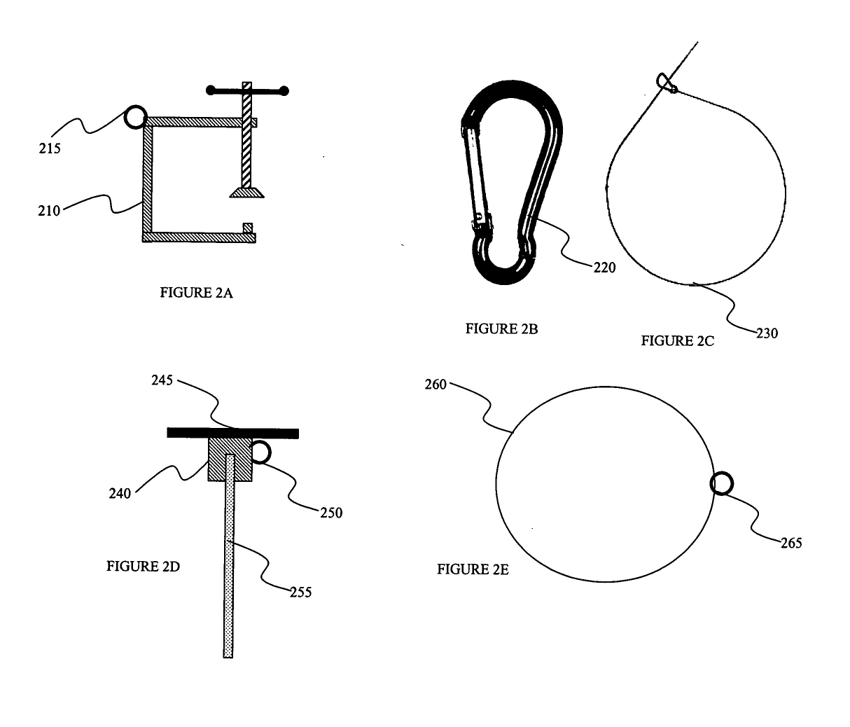

Now referring to FIGS. 2A through 2E exemplary vehicle attachment devices in accordance with a preferred embodiment of the present invention are conceptually shown. The vehicle attachment devices are intended to attach the tether 120 to a stationary object, such as a parked motor vehicle. Examples of suitable attachment devices include a C-clamp 210 as shown in FIG. 2A; a spring clip 220 (e.g., a carabiner) as shown in FIG. 2B, which may be attached to the stationary object or clasped around the tether to form a slip noose 230 as shown in FIG. 2C; a window bracket 240 to fit between an automobile side window 255 and a door or vehicle frame 245 as shown in FIG. 2C; or an anchor (i.e., an object sized to stay inside a closed door or trunk) such as a ball shown in FIG. 2D. The window bracket 240 includes a u-shaped member adapted to fit on the top edge of a retractable automotive window (e.g., a driver's or passengers side window that may be raised or lowered). Each of the attachment devices preferably includes a means for attaching the tether such as a loop, hook or clip 215, 250 & 265. The attachment devices may be comprised of various materials, though it is preferably relatively inexpensive to manufacture, durable, corrosion resistant and aesthetically pleasing.

The tether 120 is preferably a lightweight strong line, such as a nylon, polyester, aramid or coramid-based kite line; though other line materials may be used without departing from the scope of the present invention. The tether may be either mono-filament or braided. A light line will provide the steepest flying angle and the best possible performance in light winds and thermals, while heavier lines provide more steadiness and stability in breezier conditions. By way of example and not limitation, a tether length of at least forty feet is considered desirable to provide a conspicuous display and harness wind at an altitude.

The tether 120 is preferably releasably attached to a vehicle attachment device of a type depicted in FIGS. 2A, 2C, 2D and 2E using a spring clip (e.g., a carabiner) as depicted in FIG. 2B. Thus the tether can easily be securely attached and removed without damage or requiring intricate knotting or special tools. The spring clip 220 is preferably attached to the end of the tether such as by conventional crimping or knotting.

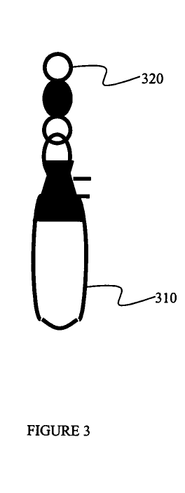

The tether 120 is preferably also releasably attached to the lifting body using a spring clip 310 and swivel 320. Snap swivels, such as those widely used in fishing and shown in FIG. 3, are well known in the art. The swivel will reduce the likelihood of undesirable tangling and twisting of the line.

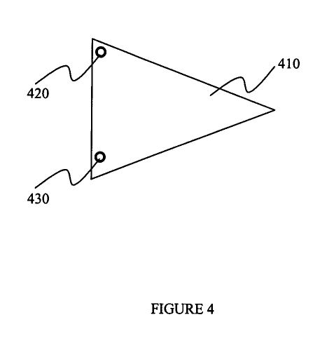

Referring now to FIG. 4, an exemplary ornament in accordance with a preferred embodiment of the present invention is shown. The depicted ornament includes a flat two-sided triangular shaped body for displaying images 410 and a pair of holes with grommets 420, 430. The body is preferably comprised of a lightweight durable material, such as (for example) a nylon or polyester. The holes provide means for securing the ornament to the tether. While two holes are shown, one hole or more than two holes may be used without departing from the scope of the present invention. Grommets are provided to help prevent tearing. Alternative means of attachment, such as hooks and clips may be used in lieu of, or in addition to, the holes and grommets. Various ornament sizes, shapes, configurations, types (e.g., memorabilia, pennants, windsocks, inflatables, banners, decorations, logos, flags, advertisements or other indicia) and constructions (e.g., rigid, flexible or inflated) may also be used without departing from the scope of the present invention.

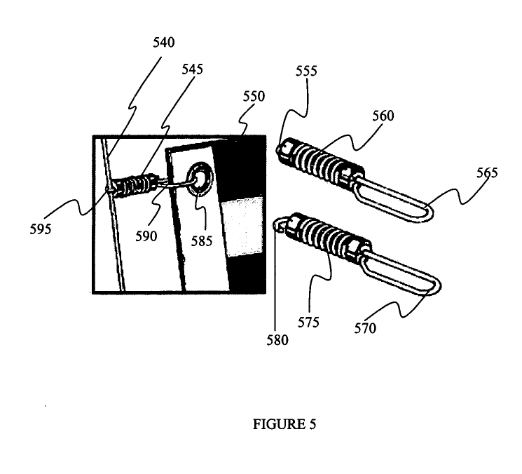

Referring now to FIG. 5 exemplary ornament attachment devices in accordance with a preferred embodiment of the present invention are conceptually illustrated. The exemplary devices are comprised of a spring-loaded clip for releasably securing an ornament at a desired position on the tether. Clips 565, 570 and 590 (i.e., ornament hooks) are attached to the ornament 550 through grommet holes 585. Spring loaded retaining hooks 555, 580 and 595 may be opened, as in 580, by compressing the spring 545, 560 and 575. Upon opening the hook, it may be slipped over the tether 540. Upon releasing the spring, the hook is closed, as in 555 and 595. A closed hook 595 can securely engage the tether 540, thus providing a means for releasably attaching an ornament to the tether.

Advantageously, the attachment device allows placement of a plurality of ornaments along the tether at selected positions. As wind subsides, ornaments can be removed to lighten the load. As wind speeds increase, ornaments can be added as desired.

An exemplary method in accordance with the present invention entails attaching one end of a tether to a lifting body such as a kite. The tether is preferably releasably attached to the lifting body using a spring clip and swivel. The other end of the tether is attached to a vehicle attachment devices. The tether is preferably releasably attached to the vehicle attachment devices using a spring clip. Next the lifting body is deployed in a conventional manner. When the lifting body reaches a desired height, the vehicle attachment devices is attached to a vehicle or other stationary object. Ornaments may be attached to the tether before or after the lifting body is aloft. When the lifting body is aloft it may be reeled in to facilitate attachment of ornaments to the tether at points that would otherwise be beyond reach.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

1. A display device including a lifting body, an attachment device, a tether securing the lifting body to the vehicle attachment device, at least one ornament, and at least one ornament attachment device adapted for releasably securing the at least one ornament to the tether.

2. A display device according to claim 1, wherein the lifting body includes a kite.

3. A display device according to claim 1, wherein the lifting body includes an object buoyant in ambient air.

4. A display device according to claim 1, wherein the vehicle attachment device includes at least one object from the group consisting of a C-clamp, spring clip, noose, window bracket, and anchor.

5. A display device according to claim 1, wherein the vehicle attachment device includes a window bracket, said window bracket including a unshaped member adapted to fit on the top edge of a retractable automotive window.

6. A display device according to claim 1, wherein the at least one ornament attachment device is comprised of a spring loaded retaining hook configured to releasably engage the tether and an ornament hook configured to releasably engage the at least one ornament, said spring loaded retaining hook being attached to the ornament hook.

7. A display device according to claim 1, wherein the at least one ornament includes an ornament from the group consisting of memorabilia, pennants, windsocks, inflatable objects, signs and banners.

8. A display device according to claim 1, wherein the at least one ornament includes at least one hole.

9. A display device according to claim 1, wherein the at least one ornament includes at least one hole and a grommet lining said at least one hole.

10. A display device including a lifting body, an attachment device, a tether securing the lifting body to the vehicle attachment device, at least one ornament, and at least one ornament attachment device adapted for releasably securing the at least one ornament to the tether, wherein
the lifting body includes an object from the group consisting of a kite and an object buoyant in ambient air, and
the vehicle attachment device includes at least one object from the group consisting of a C-clamp, spring clip, noose, window bracket, and anchor.

11. A display device according to claim 10, wherein the vehicle attachment device is comprised of a window bracket, said window bracket including a u-shaped member adapted to fit on the top edge of a retractable automotive window.

12. A display device according to claim 10, wherein the at least one ornament attachment device is comprised of a spring loaded retaining hook configured to releasably engage the tether and an ornament hook configured to releasably engage the at least one ornament, said spring loaded retaining hook being attached to the ornament hook.

13. A display device according to claim 12, wherein the at least one ornament includes an ornament from the group consisting of memorabilia, pennants, windsocks, inflatable objects, signs and banners.

14. A display device according to claim 13, wherein the at least one ornament includes at least one hole.

15. A display device according to claim 13, wherein the at least one ornament includes at least one hole and a grommet lining said at least one hole.
